(19) United States
(12) Patent Application Publication
(10) Pub. No.: US 2015/0205538 A1
(43) Pub. Date: Jul. 23, 2015

(54) STORAGE APPARATUS AND METHOD FOR SELECTING STORAGE AREA WHERE DATA IS WRITTEN

(71) Applicant: KABUSHIKI KAISHA TOSHIBA, Minato-ku (JP)

(72) Inventor: Yasuo MOTEGI, Yokohama-shi (JP)

(73) Assignee: KABUSHIKI KAISHA TOSHIBA, Minato-ku (JP)

(21) Appl. No.: 14/206,343

(22) Filed: Mar. 12, 2014

(30) Foreign Application Priority Data
Jan. 17, 2014 (JP) 2014-006878

(51) Int. Cl. G06F 3/06

(52) U.S. Cl. CPC G06F 3/0619; G06F 3/0688; G06F 3/0652

(57) ABSTRACT

According to one embodiment, a storage apparatus includes a first storage medium, a second storage medium, and a controller. The second storage medium has a lower access speed and a larger storage capacity than the first storage medium. The controller manages a part of the storage area in the first storage medium as a cache area and classifies small areas in the cache area into a first group, a second group which is less reliable than the first group, and a third group which is inhibited from being used. The controller selects a small area where first data is written from the first group or the second group based on whether the first data is dirty data or non-dirty data, when the first data is written to the cache area.

### CROSS-REFERENCE TO RELATED APPLICATIONS

This application is based upon and claims the benefit of priority from Japanese Patent Application No. 2014-006878, filed Jan. 17, 2014, the entire contents of which are incorporated herein by reference.

### FIELD

Embodiments described herein relate generally to a storage apparatus and a method for selecting a storage area where data is written.

### BACKGROUND

In recent years, storage apparatuses have been developed which comprise a plurality (for example, two) of types of nonvolatile storage media with different access speeds and different storage capacities. A hybrid drive is known as representative of such storage apparatuses. The hybrid drive generally comprises a first nonvolatile storage medium and a second nonvolatile storage medium. The second nonvolatile storage medium has a lower access speed and a larger storage capacity than that of the first nonvolatile storage medium.

A semiconductor memory, for example, a NAND flash memory, is used as the first nonvolatile storage medium. The NAND flash memory is known as a nonvolatile storage medium which has a high price per unit capacity but which can be accessed at a high speed. A disk medium, for example, a magnetic disk, is used as the second nonvolatile storage medium. The disk medium is known as a nonvolatile storage medium which has a low access speed but which has a low price per unit capacity. Thus, the hybrid drive generally uses the disk medium (more specifically, a disk drive including the disk medium) as a main storage and uses the NAND flash memory (more specifically, the NAND flash memory, which has a higher access speed than the disk medium) as a cache. This increases the access speed of the entire hybrid drive.

A storage area in the NAND flash memory is generally divided into small areas of a given size (hereinafter referred to as blocks) for use. An error correcting code (ECC) is normally added to data stored in a block. When the data is read from the block, an error in the data is detected based on the ECC. The error is then corrected based on the ECC. Even when the error is corrected, if the number of corrected bits (ECC corrected bits) exceeds a threshold, the block may be treated as a defective block inhibited from being used.

A block with the number of ECC corrected bits exceeding the threshold during data reading (hereinafter referred to as a first type of block) may cause a read error during the subsequent data reading. However, the first type of block may avoid causing a read error. In other words, the first type of block may be still usable. Thus, when the first type of block is used as a defective block, utilization efficiency of the NAND flash memory (in other words, the nonvolatile storage medium) reduces.

### BRIEF DESCRIPTION OF THE DRAWINGS

FIG. 1 is a block diagram showing an exemplary configuration of a hybrid drive according to an embodiment;

FIG. 2 is a conceptual drawing showing an exemplary format of a storage area in a NAND memory shown in FIG. 1;

FIG. 3 is a conceptual drawing showing an exemplary format of a storage area in a disk shown in FIG. 1;

FIG. 4 is a diagram showing an example of the data structure of a block management table shown in FIG. 2;

FIG. 5 is a diagram showing an example of the data structure of an erase counter table shown in FIG. 2;

FIG. 6 is an example showing an example of the data structure of a data management table shown in FIG. 3;

FIG. 7 is a flowchart showing an exemplary procedure for a block state determination process according to the embodiment; and

FIG. 8 is a flowchart showing an exemplary procedure for a write operation of writing data to the NAND memory according to the embodiment.

### DETAILED DESCRIPTION

Various embodiments will be described hereinafter with reference to the accompanying drawings.

In general, according to one embodiment, a storage apparatus comprises a first storage medium, a second storage medium, and a controller. The first storage medium is nonvolatile and comprises a storage area including a plurality of small areas. The second storage medium is nonvolatile and has a lower access speed and a larger storage capacity than the first storage medium. The controller is configured to manage a part of the storage area in the first storage medium as a cache area and to access the first storage medium and the second storage medium. The controller is further configured to classify the small areas in the cache area into a first group, a second group which is less reliable than the first group, and a third group which is inhibited from being used. The controller is further configured to select a small area where first data is written from the first group or the second group based on whether the first data is dirty data not written to the second storage medium or non-dirty data already written to the second storage medium, when the first data is written to the cache area.

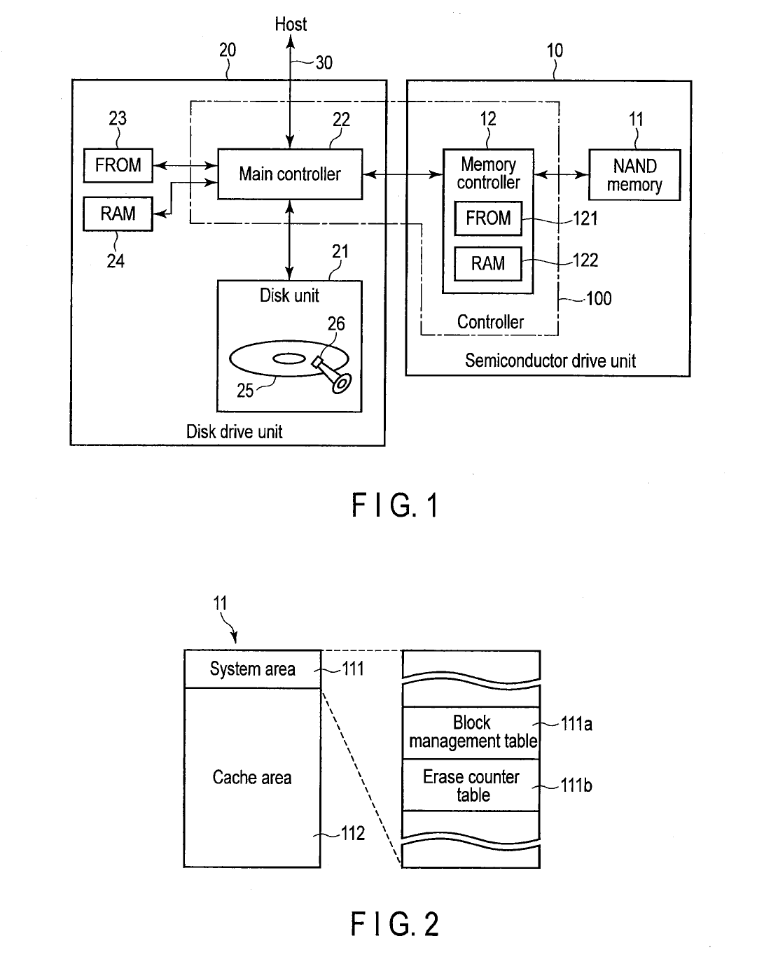

FIG. 1 is a block diagram showing an exemplary configuration of a hybrid drive according to an embodiment. The hybrid drive comprises a plurality of types, for example, two types, of nonvolatile memory media with different access speeds and different storage capacities (in other words, a first nonvolatile storage medium and a second nonvolatile storage medium). The embodiment uses a NAND flash memory (hereinafter referred to as a NAND memory) 11 as the first nonvolatile storage medium and uses a magnetic disk medium (hereinafter referred to as a disk) 25 as the second nonvolatile storage medium. The disk 25 has a lower access speed and a larger storage capacity than that of the NAND memory 11.

The hybrid drive shown in FIG. 1 comprises a semiconductor drive unit 10 such as a solid-state drive (SSD) and a disk dive unit 20 such as a hard disk drive (HDD). The semiconductor drive unit 10 includes the NAND memory 11 and a memory controller 12.

The memory controller 12 controls access to the NAND memory 11 in accordance with an access command (for example, a write command or a read command) from a main controller 22 in the disk drive unit 20. The memory controller 12 performs this control in accordance with a first control program. According to the embodiment, in order to increase the speed of access from a host apparatus (hereinafter referred to as a host) to the hybrid drive, the NAND memory 11 is used as a cache (a cache memory) where data lately accessed by the host is stored. The host utilizes the hybrid drive shown in FIG. 1 as a storage apparatus for the host.

The memory controller 12 includes a flash read only memory (FROM) 121 and a random access memory (RAM) 122. FROM 121 is a rewritable nonvolatile memory and is used to store the first control program. A part of a storage area in RAM 122 is used as a work area for the memory controller 12. FROM 121 and RAM 122 may be provided outside the memory controller 12.

The disk drive unit 20 includes a disk unit 21, the main controller 22, FROM 23, and RAM 24. The disk unit 21 includes the disk 25 and a head 26. The disk 25 comprises a recording surface, for example, on one surface thereof, where data is magnetically recorded. The head 26 is disposed in association with the recording surface. The head 22 is used to write data to the disk and to read data from the disk.

The main controller 22 is connected to the host via a host interface (storage interface) 30. The main controller 22 functions as a host interface controller which receives signals transferred by the host and which transfers signals to the host. Specifically, the main controller 22 receives access requests (a write request, a read request, and the like) transferred by the host. The main controller 22 also controls data transfer between the host and the main controller 22.

The main controller 22 functions as an access controller that controls access to the NAND memory 11 via the memory controller 12 and access to the disk 25 via the head 26, in accordance with an access request (for example, a write request or a read request from the host). The main controller 22 performs the above-described control in accordance with a second control program. According to the embodiment, the second control program is stored in FROM 23. A part of a storage area in RAM 24 is used as a work area for the main controller 22.

The memory controller 12 and the main controller 22 provide a controller 100 for the entire hybrid drive. In other words, the functions of the controller 100 according to the embodiment are distributed between the semiconductor drive unit 10 and the disk drive unit 20 as the memory controller 12 and the main controller 22, respectively. However, the controller 100 may be provided independently of the semiconductor drive unit 10 and the disk drive unit 20.

Furthermore, an initial program loader (IPL) may be stored in FROM 23, and the second control program may be stored in the disk 25. In this case, when the hybrid drive is powered on, the main controller 22 may execute the IPL and thus loads the second control program from the disk 25 into, for example, RAM 24.

FIG. 2 is a conceptual drawing showing an exemplary format of a storage area in the NAND memory 11 shown in FIG. 1. The storage area in the NAND memory 11 is partitioned into a system area 111 and a cache area 112 as shown in FIG. 2. In other words, the NAND memory 11 comprises the system area 111 and the cache area 112. The system area 111 is used to store information utilized by the system (for example, the memory controller 12) for management. The cache area 112 is used to store data lately accessed by the host.

The storage area in the NAND memory 11 is divided into small areas each of a given size generally referred to as blocks. In other words, the storage area in the NAND memory 11 comprises a plurality of blocks (small areas). In the NAND memory 11, data is collectively erased in units of blocks. In other words, the block is a unit of data erasure.

A part of the system area 111 is used to store a block management table 111a and an erase counter table 111b. In the block management table 111a, for example, block (small area) management information is stored for each block in the cache area 112. The block management information is indicative of the state of a corresponding block, for example, the reliability of the block.

In the erase counter table 111b, for example, erase counter information is stored for each block in the NAND memory 11. The erase counter information is indicative of the number of times the corresponding block has been erased.

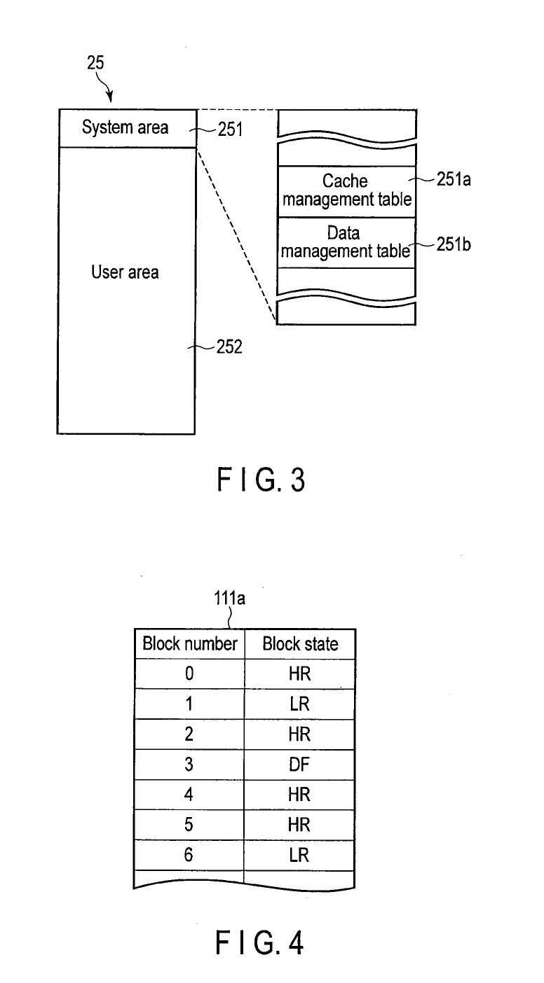

FIG. 3 is a conceptual drawing showing an exemplary format of a storage area in the disk 25 shown in FIG. 1. The disk 25 is partitioned into a system area 251 and a user area 252 as shown in FIG. 3. In other words, the disk 25 comprises the system area 251 and the user area 252. The system area 251 is used to store information utilized by the system (for example, the main controller 22) for management. The user area 252 is a storage area that can be used by a user.

A part of the system area 251 is used to store a cache management table 251a and a data management table 251b. The cache management table 251a is used to manage the cache area 112 in the NAND memory 11. Specifically, in the cache management table 251a, cache management information is stored for each block in the cache area 112. The cache management information includes the identifier (for example, the block number) of a corresponding block and the logical block address (LBA) of data stored in the block. The logical block address is indicative of a location in a logical address space recognized by the host.

In the data management table 251b, for example, data management information is stored for each logical block address (in other words, for each logical block address in the logical address space). The data management information is indicative of data at a corresponding logical block address (more specifically, data logically stored at the corresponding logical block address).

FIG. 4 shows an example of the data structure of the block management table 111a shown in FIG. 2. The block management table 111a has entries associated respectively with blocks in the NAND memory 11 (more specifically, a block in the cache area 112 in the NAND memory 11). Each of the entries in the block management table 111a is used to store block management information for the corresponding block.

The block management information includes a block identifier and block state information. The block identifier is, for example, a block number specific to the corresponding block. The block state information is indicative of the state of the corresponding block, for example, the reliability of the block. According to the embodiment, the reliability indicated by the block state information is high reliability (HR), low reliability (LR), or no reliability (DF). In other words, the block state information indicates whether the corresponding block is a high-reliability block (a second type of block), a low-reliability block (a first type of block), or a defective block (a third type of block).

As described above, a set of blocks in the NAND memory 11 (more specifically, a set of blocks in the cache area 112) is classified into a high-reliability group (a first group), a low-reliability group (a second group), and a defective group (a third group) according to the embodiment. The high-reliability group is a set of high-reliability blocks, and the low-reliability group is a set of low-reliability blocks. The defective group is a set of defective blocks.

According to the embodiment, the initial value of the block state information in the block management information indicates that the corresponding block is a high-reliability block. In other words, in an initial state where the use of the hybrid drive shown in FIG. 1 is started, all the blocks in the cache area 112 are managed as high-reliability blocks using the block management table 111a, according to the embodiment. All the blocks in the NAND memory 11 may be classified into the high-reliability group, the low-reliability group, or the defective group. In other words, the block management table 111a may have entries associated respectively with all the blocks in the NAND memory 11.

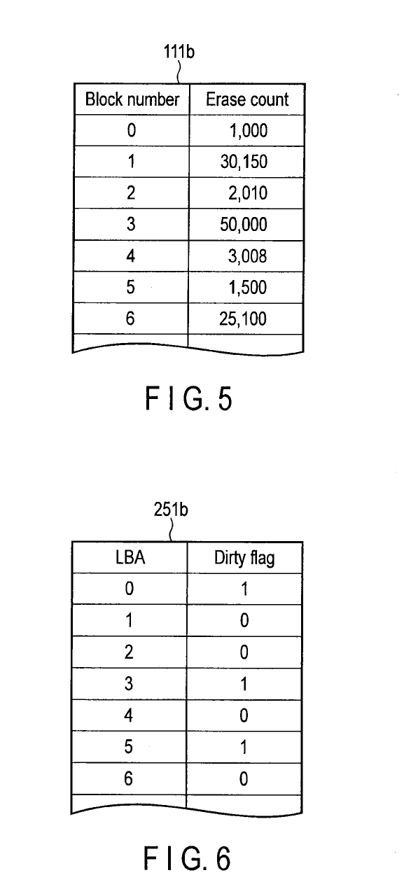

FIG. 5 shows an example of the data structure of the erase counter table 111b shown in FIG. 2. The erase counter table 111b has entries associated respectively with blocks in the NAND memory 11. Each of the entries in the block management table 111a is used to store erase counter information for the corresponding block. The erase counter information includes a block identifier (block number) and an erase count. The erase count is indicative of the number of times the corresponding block has been erased.

FIG. 6 shows an example of the data structure of the data management table 251b shown in FIG. 3. The data management table 251b is assumed to have entries associated with, for example, all the respective logical block addresses in the logical address space recognized by the host. Each of the entries in the data management table 251b is used to store data management information.

The data management information includes a corresponding logical block address and a dirty flag. The dirty flag indicates the state of data logically stored at the corresponding logical block address, for example, whether the data is dirty data or non-dirty data. The dirty data refers to data written to the NAND memory 11 (more specifically, the cache area 112 in the NAND memory 11) and not written to the disk 25. The non-dirty data refers to data written both to the NAND memory 11 and to the disk 25.

Furthermore, according to the embodiment, data written to the disk 25 and not written to the cache area 112 in the NAND memory 11 is considered to be non-dirty data. However, such data may be managed as a different type of data that is neither dirty data nor non-dirty data.

Now, operations of the embodiment will be described. First, an operation will be described which is performed when the main controller 22 issues a write command to the memory controller 12 in the semiconductor drive unit 10. The write command is assumed to indicate to the memory controller 12 the need to write data (first data) D to the cache area 112 in the NAND memory 11. Furthermore, it is assumed that the logical block address of the data D is LBAi.

The main controller 22 determines whether the write data D (in other words, the data to be written to the cache area 112 in the NAND memory 11) is already stored in the disk 25 as data at logical block address LBAi. If the write data D is already stored in the disk 25, the main controller 22 sets the dirty flag (makes the flag logical 1) in the data management information (first data management information) stored in an entry (hereinafter referred to as entry (i)) in the data management table 251b associated with logical block address LBAi. Conversely, if the write data D is not stored in the disk 25, the main controller 22 clears the dirty flag (makes the flag logical 0) in the data management information stored in entry (i) in the data management table 251b.

According to the embodiment, the write data D is write-back data, write-through data, or read-steal data. The write-back data refers to the write data D used in a case where the host makes a data write request to the hybrid drive in a write-back mode. The write-back mode refers to a mode where the write data D (write-back data) is written to the cache area 112 in the NAND memory 11 in accordance with the write request from the host and where a response indicative of write completion is returned to the host in response to the completion of the writing. In the write-back mode, the writing of the write data D (write-back data) to the disk 25 is performed, for example, while the disk drive unit 20 is free (idle time), after the response indicative of write completion is returned to the host. The writing of the write data D to the disk 25 changes the write data D from dirty data to non-dirty data.

Thus, when the write data D is writ-back data, the main controller 22 first sets the dirty flag in entry (i) in the data management table 251b. The main controller 22 then clears the dirty flag in entry (i) after the write data is also written to the disk 25.

The write-through data refers to the write data D used in a case where the host makes a data write request to the hybrid drive in a write-through mode. The write-through mode refers to a mode where the write data D (write-through data) is written to the cache area 112 in the NAND memory 11 in accordance with the write request from the host and where, in parallel with the writing, the write data D is also written to the disk 25.

In the write-through mode, a response indicative of write completion is returned to the host in response to completion of the writing of the write data D to the disk 25. Thus, when the write data D is write-through data, the main controller 22 clears the dirty flag in entry (i) in the data management table 251b.

The read-steal data refers to the data D read from the disk 25 as a result of a cache miss in response to a read request from the host. The data D is used as read data D requested by the host and as the write data D to be written to the cache area 112. Thus, when the write data D is read-steal data, the main controller 22 clears the dirty flag in the data management information stored in entry (i) in the data management table 251b.

After manipulating the dirty flag as described above, the main controller 22 issues a write command to the memory controller 12.

Now, a read operation according to the embodiment will be described. First, it is assumed that the host has issued a read request to the hybrid drive shown in FIG. 1. The read request includes a start logical address and size information indicative of the size of data to be read (read data). It is assumed herein that the start logical address is indicative of logical block address LBAi and that the size of the read data is equal to the size of one block.

The read request from the host is received by the main controller 22 in the hybrid drive. The main controller 22 acquires, from the cache management table 251a, cache management information including logical block address LBAi indicated in the received read request. Here, the main controller 22 is assumed to have successfully acquired the cache management information including logical block address LBAi. In other words, the received read request is assumed to have hit the cache. Furthermore, the cache management information acquired is assumed to include a block number (j). In this case, the main controller 22 issues, to the memory controller 12, a read command specifying reading of data from a block BLKj (a first small area) denoted by the block number (j).

The memory controller 12 reads data from block BLKj in the cache area 112 in the NAND memory 11 in accordance with the read command from the main controller 22. Then, the memory controller 12 determines whether the read data is correct based on the ECC added to the read data.

If the read data is correct, the memory controller 12 returns the read data to the main controller 22. Conversely, if the read data is not correct, the memory controller 12 corrects the error in the read data based on the ECC. If the error in the read data can be corrected, the memory controller 12 returns the data with the error corrected to the main controller 22. The main controller 22 returns the data returned by the memory controller 12 to the host as a response to the read request from the host. Furthermore, if the error in the read data fails to be corrected, the memory controller 12 reports a read error to the main controller 22.

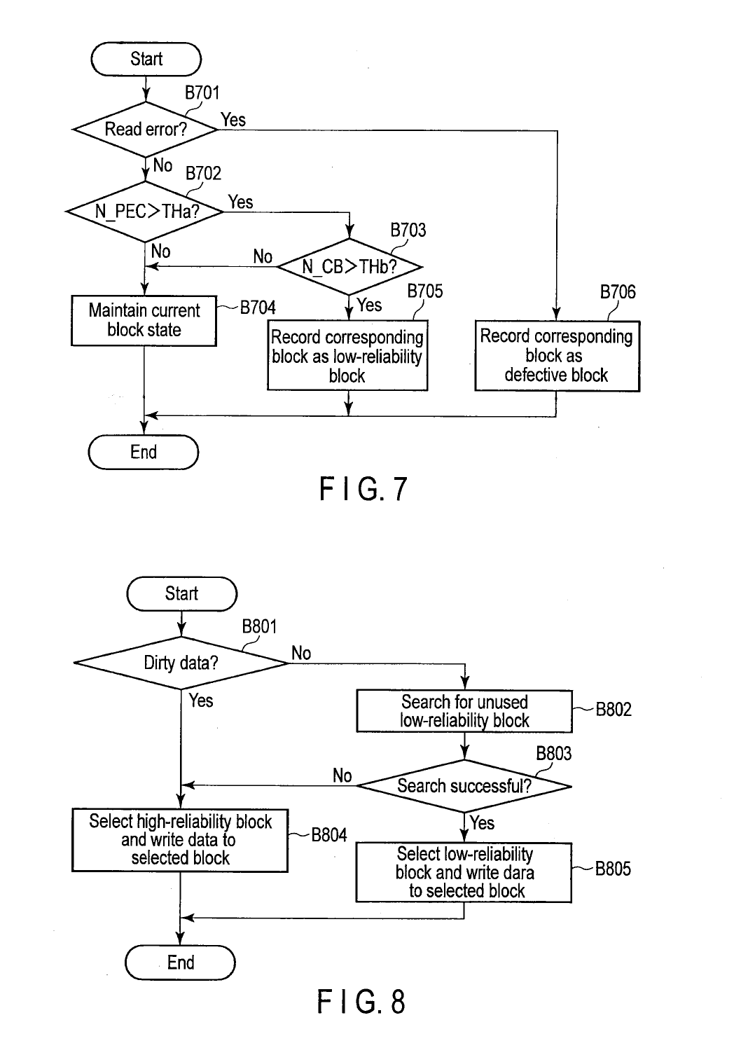

Upon reading the data from block BLKj, the memory controller 12 executes a block state determination process for determining the reliability of block BLKj. The block state determination process will be described with reference to FIG. 7. FIG. 7 is a flowchart showing an exemplary procedure for the block state determination process.

First, the memory controller 12 determines whether a read error has occurred during data reading from block BLKj (B701). If no read error has occurred (No in B701), the memory controller 12 determines whether the number of program/erase (P/E) cycles N_PEC for block BLKj is larger than a threshold THa (a second threshold) (B702). The number N_PEC of P/E cycles for block BLKj refers to the number of times block BLKj has been erased. Thus, the memory controller 12 acquires erase count information including the block number (j) of block BLKj from the erase counter table 111b. The memory controller 12 uses an erase count included in the erase count information as the number N_PEC of P/E cycles.

If the number N_PEC of P/E cycles is larger than the threshold THa (Yes in B702), the memory controller 12 proceeds to B703. In B703, the memory controller 12 determines whether the number N_CB of ECC corrected bits is larger than a threshold THb (a first threshold). The number N_CB of ECC corrected bits is the number of bits corrected based on the ECC when the data is read from block BLKj.

If the number N_CB of ECC corrected bits is not larger than the threshold THb (No in B703), the memory controller 12 proceeds to B704. The memory controller 12 also proceeds to B704 if the number N_PEC of P/E cycles is not larger than the threshold THa (No in B702).

In B704, the memory controller 12 maintains the current state of block BLKj. That is, the memory controller 12 keeps the block management information stored in the block management table 111a and including the block number (j) of block BLKj, in other words, the block state information in the block management information (first small area management information) on block BLKj, in a state indicative of the current reliability. Thus, when block BLKj is a high-reliability block, block BLKj is kept as a high-reliability block. When block BLKj is a low-reliability block, block BLKj is kept as a low-reliability block.

Conversely, if the number N_CB of ECC corrected bits is larger than the threshold THb (Yes in B703), the memory controller 12 proceeds to B705. In B705, the memory controller 12 records block BLKj in the block management table 111a as a low-reliability (LR) block. That is, the memory controller 12 sets the block state information in the block management information (first small area management information) on block BLKj to a state indicative of low reliability (LR). Thus, when block BLKj is a high-reliability block, block BLKj is changed to a low-reliability block. When block BLKj is a low-reliability block, block BLKj is maintained as a low-reliability block.

On the other hand, if a read error occurs during data reading from block BLKj (Yes in B701), the memory controller 12 proceeds to B706. In B706, the memory controller 12 records block BLKj in the block management table 111a as a defective (DF) block. That is, the memory controller 12 changes the block state information in the block management information on block BLKj from information indicative of high reliability (HR) or low reliability (LR) to information indicative of a defect (DF).

Thus, according to the embodiment, the memory controller 12 determines the block state (in other words, the reliability) of block BLKj based on the number of P/E cycles N_BEC and the number N_CB of ECC corrected bits. However, the block state (in other words, the reliability) of block BLKj may be determined based on the number N_CB of ECC corrected bits (in other words, a read result).

Now, with reference to FIG. 8, description will be given which relates to a write operation of writing data to the NAND memory 11 (more specifically, the cache area 112 in the NAND memory 11) according to the embodiment. FIG. 8 is a flowchart showing an exemplary procedure for the write operation. Such a write operation is also referred to as a program operation.

Now, it is assumed that, after the dirty flag in entry (i) in the data management table is manipulated, the main controller 22 issues, to the memory controller 12, a write command specifying writing of the data D to the cache area 112 in the NAND memory 11, as described above. It is further assumed that the logical block address of the data D is LBAi and that the write command includes information indicating whether the data D is dirty data or non-dirty data.

The memory controller 12 determines whether the data D specified in the write command is dirty data based on the write command from the main controller 22 (B801). If the data D is not dirty data (No in B801), in other words, if the data is non-dirty data, the memory controller 12 determines that the data D is already stored in the disk 25.

In this case, the memory controller 12 searches the cache area 112 in the NAND memory 11 for a currently unused low-reliability block (in other words, a free low-reliability block) (B802). The memory controller 12 performs the search for an unused low-reliability block based on the block management table 111a and a free block list. The free block list is a list where the block numbers of blocks not used to store data (in other words, free blocks) and which are included in the blocks in the cache area 112 are recorded. In other words, the memory controller 12 searches a set of unused blocks shown in the free block list for a block shown in the block management table 111a to be a low-reliability block, which block corresponds to an unused low-reliability block.

Then, the main controller 22 determines whether an unused low-reliability block has been successfully searched for (B803). If the search for an unused low-reliability block has failed (No in B803), the memory controller 12 proceeds to B804. Furthermore, when the data D is dirty data (Yes in B801), the memory controller 12 also proceeds to B804.

In B804, the memory controller 12 selects an unused high-reliability block based on the block management table 111a and the free block list. In B804, the memory controller 12 further writes the data D to the selected high-reliability block. Thus, even when the data D is dirty data, which is not written to the disk 25, the embodiment enables a sufficient reduction in the probability that the data D fails to be read from the hybrid drive shown in FIG. 1.

On the other hand, if the search for an unused low-reliability block has succeeded (Yes in B803), the memory controller 12 proceeds to B805. In B805, the memory controller 12 selects the searched-for unused low-reliability block. In B805, the memory controller 12 further writes the data D to the selected low-reliability block.

The data D written to the low-reliability block is non-dirty data already written to the disk 25 (more specifically, non-dirty data at logical block address LBAi). Thus, the embodiment allows the data D to be read normally from the disk 25 even when the data D fails to be read normally from a low-reliability block during a read operation executed after writing of the data D to the low-reliability block. As described above, the embodiment uses low-reliability blocks that may cause a read error as a result of advanced exhaustion, for saving of non-dirty data (in other words, data permitted to disappear from the NAND memory 11). The embodiment thus enables each of the blocks in the NAND memory 11 to be used for a long period, allowing the NAND memory 11 to be efficiently used.

Moreover, a read error does not always occur during reading of the data D written to a low-reliability block, and it is sufficiently possible that the data D is read normally. In other words, the embodiment allows the data D to be read at high speed while effectively utilizing low-reliability blocks treated as defective blocks according to conventional techniques. Thus, compared to the conventional techniques, the embodiment allows the NAND memory 11 to be used for a long period, enabling extension of a period when the hybrid drive operates as the hybrid drive.

Upon executing B804 and B805, the memory controller 12 returns the block number of the block to which the data D is written to the main controller 22 as a response indicative of write completion. Thus, the memory controller 12 completes executing the write command from the main controller 22. It is assumed herein that the block to which the data D is written is block BLKj and block BLKj has a block number of (j). In this case, the main controller 22 updates the logical block address in the cache management information associated with block BLKj to LBAi.

The above-described write operation is performed when the host makes a data write request to the hybrid drive in the write-back mode or the write-through mode. The above-described write operation is also performed when the data D (in other words, the data at logical block address LBAi) is read from the disk 25 as a result of a cache miss in response to a read request from the host. In this case, the read data D (read-steal data) is used as write data as described above.

The above-described write operation is also performed, for example, during a garbage collection process autonomously executed by the memory controller 12. The garbage collection process is a process of collectively moving valid data from a plurality of partially invalid blocks (a plurality of blocks with what is called gaps present therein) to another block in the NAND memory 11. In the garbage collection process, the state of the data (in other words, whether the data is dirty data or non-dirty data) present before movement of data is maintained after the movement. The garbage collection process is generally executed as a background process for an access process requested by the host.

At least one embodiment described above allows the utilization efficiency of the nonvolatile storage medium to be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage apparatus comprising:
a first storage medium comprising a storage area including a plurality of small areas, the first storage medium being nonvolatile;
a second storage medium having a lower access speed and a larger storage capacity than the first storage medium, the second storage medium being nonvolatile;
a controller configured to manage a part of the storage area in the first storage medium as a cache area and to access the first storage medium and the second storage medium,
wherein the controller is further configured to:
classify the small areas in the cache area into a first group, a second group which is less reliable than the first group, and a third group which is inhibited from being used; and
select a small area where first data is written from the first group or the second group based on whether the first data is dirty data not written to the second storage medium or non-dirty data already written to the second storage medium, when the first data is written to the cache area.

2. The storage apparatus of claim 1, wherein the controller is further configured to determine whether a first small area in the cache area is classified into the first group, the second group, or the third group based on a read result of reading of data from the first small area.

3. The storage apparatus of claim 2, wherein:
the read result includes a number of bits corrected when an error in the data read from the first small area is corrected based on an error correcting code added to the read data; and
the controller is further configured to classify the first small area into the second group when the number of corrected bits is larger than a first threshold.

4. The storage apparatus of claim 3, wherein:
data is erased for each of the plurality of small areas; and
the controller is further configured to classify the first small area into the second group when a number of times the data in the first small area has been erased is larger than a second threshold and the number of corrected bits is larger than the first threshold and to classify the first small area into the first group when the number of times the data in the first small area has been erased is larger than the second threshold but the number of corrected bits is smaller than the first threshold.

5. The storage apparatus of claim 2, wherein the controller is further configured to:
manage whether each of the small areas in the cache area is classified into the first group, the second group, or the third group using management information associated with each of the small areas; and
update the management information associated with the first small area based on the determination.

6. The storage apparatus of claim 1, wherein the controller is further configured to manage whether each of the small areas in the cache area is classified into the first group, the second group, or the third group using management information associated with each of the small areas.

7. The storage apparatus of claim 1, wherein the controller is further configured to:
manage whether data logically stored at a logical block address in a logical address space recognized by a host apparatus utilizing the storage apparatus is the dirty data or the non-dirty data, using management information; and
set management information corresponding to a first logical block address where the first data is logically stored based on whether the first data is written to the second storage medium, when the first data is written to the cache area.

8. A method for selecting a storage area where data is written in a controller of a storage apparatus comprising a first storage medium comprising a storage area including a plurality of small areas and a second storage medium having a lower access speed and a larger storage capacity than the first storage medium, the first and the second storage medium being nonvolatile, the method comprising:
managing a part of the storage area in the first storage medium as a cache area;
classifying the small areas in the cache area into a first group, a second group which is less reliable than the first group, and a third group which is inhibited from being used; and
selecting a small area where first data is written from the first group or the second group based on whether the first data is dirty data not written to the second storage medium or non-dirty data already written to the second storage medium, when the first data is written to the cache area.

9. The method of claim 8, further comprising determining whether a first small area in the cache area is classified into the first group, the second group, or the third group based on a read result of reading of data from the first small area.

10. The method of claim 9, wherein:
the read result includes a number of bits corrected when an error in the data read from the first small area is corrected based on an error correcting code added to the read data; and
the method further comprises classifying the first small area into the second group when the number of corrected bits is larger than a first threshold.

11. The method of claim 10, wherein:
data is erased for each of the plurality of small areas; and
the method further comprises
classifying the first small area into the second group when a number of times the data in the first small area has been erased is larger than a second threshold and the number of corrected bits is larger than the first threshold; and
classifying the first small area into the first group when the number of times the data in the first small area has been erased is larger than the second threshold but the number of corrected bits is smaller than the first threshold.

12. The method of claim 9, further comprising:
managing whether each of the small areas in the cache area is classified into the first group, the second group, or the third group using management information associated with each of the small areas; and
updating the management information associated with the first small area based on the determination.

13. The method of claim 8, further comprising managing whether each of the small areas in the cache area is classified into the first group, the second group, or the third group using management information associated with each of the small areas.

14. The method of claim 8, further comprising:
managing whether data logically stored at a logical block address in a logical address space recognized by a host apparatus utilizing the method is the dirty data or the non-dirty data, using management information; and
setting management information corresponding to a first logical block address where the first data is logically stored based on whether the first data is written to the second storage medium, when the first data is written to the cache area.
